(19) United States
(12) Patent Application Publication
(10) Pub. No.: US 2018/0118249 A1
(43) Pub. Date: May 3, 2018

(54) Cam Clamping Mechanism and Associated Steering Column

(71) Applicant: Robert Bosch Automotive Steering Vendome, Vendome (FR)

(72) Inventors: Eddy Dupont, Vendome (FR); Alexandre Sarandao, La Chapelle-Enchérie (FR)

(21) Appl. No.: 15/566,421

(22) PCT Filed: Apr. 13, 2016
(86) PCT No.: PCT/FR2016/050850

§ 371 Date: Oct. 13, 2017

(30) Foreign Application Priority Data
Apr. 15, 2015 (FR) 1553331

(51) Int. Cl. B62D 1/184; F16B 21/16

(52) U.S. Cl. CPC B62D 1/184; F16B 21/165

(57) ABSTRACT

A cam lock mechanism used for locking an adjustable steering column in a position comprises a fixed cam (52)defining a geometric reference plane (101) for the lock mechanism, a tensioning member (16), the tensioning member being able to move at least translationally with respect to the fixed cam parallel to a locking axis (100) perpendicular to the reference plane, in a tensioning direction; and a mobile cam (54) able to move with respect to the fixed cam along a pathway in a locking direction and interacting with the fixed cam in such a way that movement of the mobile cam along the pathway in the locking direction causes translational movement of the tensioning member (16) parallel to the locking axis in the tensioning direction. The mobile cam (54) and the fixed cam (52) are configured in such a way that there is a continuous function linking the movement of the mobile cam in the, locking direction with the translational movement of the tensioning member parallel to the locking axis in the tensioning direction, this continuous function having a derivative which is a decreasing son-constant function.

### TECHNICAL FIELD OF THE INVENTION

The invention relates to a mechanism for clamping an adjustable steering column, holding the steering column in a position chosen by the driver.

### PRIOR ART

The steering column of a vehicle may be adjustable for depth and/or height according to the driver. Once the adjustments have been made, the steering column must be held locked in the chosen position in order to prevent any change in position of the steering column while the vehicle is being driven. A locking mechanism, manual or motorised, effects this locking and can however easily and quickly release the steering column to allow a further adjustment.

In the document FE 2917362, an electrical device for clamping a steering column of a motor vehicle that is adjustable for depth and/or height is described. The steering column comprises a steering shaft mounted so as to rotate about a steering axis in a tube body and is mounted in a support assembly comprising a fixed support element and a movable support element. The fixed support element consists of two uprights parallel to a vertical steering plane passing through the steering axis, and a base connecting the two uprights. The tube body is disposed in the movable support element itself disposed between the uprights of the fixed support element, and is locked on the fixed support element in a locked position by a clamping system on a clamping axis substantially parallel to the vertical steering plane passing through the steering axis. The clamping system comprises a clamping rod lying in the clamping axis, and which passes through the two uprights of the fixed support element. The electrical locking device comprises a locking assembly, belonging to the clamping system and mounted on the clamping rod, which consists of a cam fixed with respect to rotation with respect to the clamping axis, a cam able to rotate, and at least one rolling body disposed between the fixed cam and the movable cam. The rolling body, or each rolling body, moves on a fixed rolling track provided on the fixed cam, and on a movable rolling track provided on the movable cam. Each rolling track has a slope for release of the rolling body with respect to the corresponding cam, so that, in turning the movable cam with respect to the fixed cam, the two cams separate or move closer to each other in the rotation direction, in order to obtain the locked or unlocked position of the steering column. The release slope of the running tracks has a value lower than the value relating to the coefficient of friction with the rolling body. Each rolling track forms a curve that has a radius variable with respect to the clamping axis, so that in turning the movable cam with respect, to the fixed cam, one or more rolling tracks never interferes with itself or with the other rolling tracks; the axial movement of the movable cam with respect to the fixed cam is dependent on the rotation of the movable cam, and depends at each instant on the position of the rolling body or rolling bodies with respect to the clamping axis and the release slope of the rolling tracks for said position.

It is found that, with a device of this type, the travel between the unlocked position and the locked position begins with a taking up of the clearances existing between the parts constituting the system. When all the clearances have been taken up, a phase of progressive and successive deformations of the various elements acting in the clamping system begins, until the required locking is achieved. The driving torque necessary for the driving of the movable cam increases greatly during these various phases, which results in an increase in the power demanded of the motor. These variations in torque and power cause variations in the noise level of the system and also require an oversizing of the electric motor in order to ensure effective locking of the clamping mechanism. It would naturally be possible to control the motor at constant torque with a variable power supply controlled by a closed-loop control circuit according to a set torque point, but this gives rise to extra cost and technical constraints in the control of the motor.

### DISCLOSURE OF THE INVENTION

The invention aims to remedy the drawbacks of the prior art and to reduce the variations in driving torque, or more generally the variations in the power necessary for clamping a clamping mechanism of the aforementioned type, in order to tend as far as possible towards a functioning at constant power throughout the duration of the clamping phase.

To do this and to achieve clamping g of an adjustable steering column in a position, according to a first aspect of the invention a cam clamp mechanism is proposed comprising a fixed cam defining a geometric reference plane of the clamping mechanism, a movable member for tensioning at least in translation with respect to the fixed cam parallel to a clamping axis perpendicular to the reference plane in a tensioning direction, and a movable cam able to move with respect to the fixed cam in a movement path in a clamping direction. The movable cam interacts with the fixed cam so that a movement of the movable cam in the movement path in the clamping direction causes a translation of the tensioning member parallel to the clamping axis in the tensioning direction. Remarkably, the movable cam and the fixed cam are conformed so that it exists a continuous function linking the movement of the movable cam in the clamping direction to the translation of the tensioning member parallel to the clamping axis in the tensioning direction, having a derivative which is a decreasing non-constant function.

The derivative of the continuous function linking the movement of the movable cam in the clamping direction to the translation of the tensioning member parallel to the clamping axis in the tensioning direction corresponds to a transmission ratio of the transmission stage formed by the two cams. By imposing this decreasing ratio as the locking progresses, an increase in the force transmitted to the tensioning member, for a given available power, is allowed.

Preferably, the movement path comprises a first part in which the derivative takes values higher than a first given threshold value, and a second part in which the derivative takes values lower than a second given threshold value, the first threshold value being higher than the second threshold value in a ratio greater than 2, and preferably greater than 4. The first part of the movement path may for example correspond to a phase of taking up the clearances in the mechanism, and the second part of the movement path may for example correspond to a phase of deformation of one or more elements constituting the steering column system in which the clamping mechanism is installed.

According to one embodiment, part of the movement path corresponds to a derivative of the zero value. This part of the path is preferably situated, in the clamping direction, after the first and second parts mentioned above, and may correspond to an end-of-locking phase, making it possible to achieve a stable position.

Where applicable, it is possible to provide a so-called locking part of the movement path for which the derivative takes negative values. Preferably the movement path may include a so-called locking part as an end-of-travel position in the clamping direction. This part of the path may where applicable follow a path, part with zero derivative.

According to one embodiment, the tensioning member comprises a tensioning rod, extending parallel to the reference geometric axis.

Preferably, the clamping mechanism comprises one or more rolling bodies that roll on rolling tracks formed on the movable cam and the fixed cam. Each cam may comprise one, or preferably a plurality of rolling tracks. A single rolling body preferably corresponds to each rolling track of the movable cam and of the fixed cam. The rolling bodies may consist of balls, cylindrical or conical rollers, needles or barrels. Apart from their prime function of limiting friction between the cams, the rolling bodies offer the advantage of reducing the angular travel of the cams with respect to each other, for a given movement of the tensioning member. According to one embodiment, one or more of the rolling tracks of at least one of the cams consist of grooves with a depth varying with a non-constant slope.

According to one embodiment, the clamping mechanism further comprises an actuator directly or indirectly driving the movable cam on the movement path. Preferably, the actuator is an electric motor, preferably a DC electric motor supplied for example at constant voltage in pulse width modulation, without varying the duty factor. Alternatively, the actuator may be a hydraulic cylinder.

According to one embodiment, the actuator rotates the movable cam about the clamping axis. The driving may be direct or preferably by means of a transmission stage with or without angular member, for example a worm system.

According to another embodiment, the actuator drives the movable cam in translation, preferably perpendicular to the clamping axis. In the case of a rotary motor, a movement transformation stage will be provided between the drive shaft and the movable cam, for example a rack a pinion system.

According to another aspect of the invention, this clamping mechanism is integrated in at steering column system comprising a fixed support and a steering column tube body able to move with respect to the fixed support, the end of the tensioning member being secured to the fixed support in the tensioning direction.

Preferably, the movable cam and the fixed cam of the clamping mechanism are conformed so that, when the actuator drives the movable cam at constant speed in the clamping direction, the actuator supplies to the movable cam a constant mechanical power, or one varying by less than 10% over the movement path. Preferably, the movable cam and the fixed earn are conformed so that the movement path of the movable cam in the clamping direction does not cause any significant increase in the driving torque of the actuator.

This operating mode at constant power and torque makes it possible to reduce the power of the motor necessary for the final locking of the steering column and therefore to reduce its weight, size and cost. In addition, by optimizing the operating torque of the motor, the noise nuisances are also reduced. The optimisation of the driving torque also allows optimisation of the operating speed of the clamping mechanism.

### BRIEF DESCRIPTION OF THE FIGS.

Other features and advantages of the invention will emerge from a reading of the following description with reference to the accompanying FIGS., which illustrate;

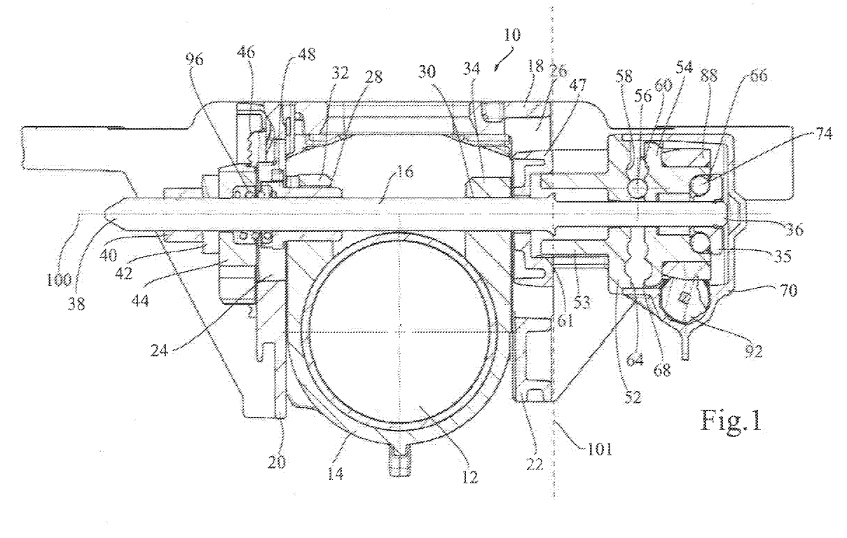

FIG. 1, a cross section of a steering column comprising a clamping mechanism according to a first embodiment of the invention;

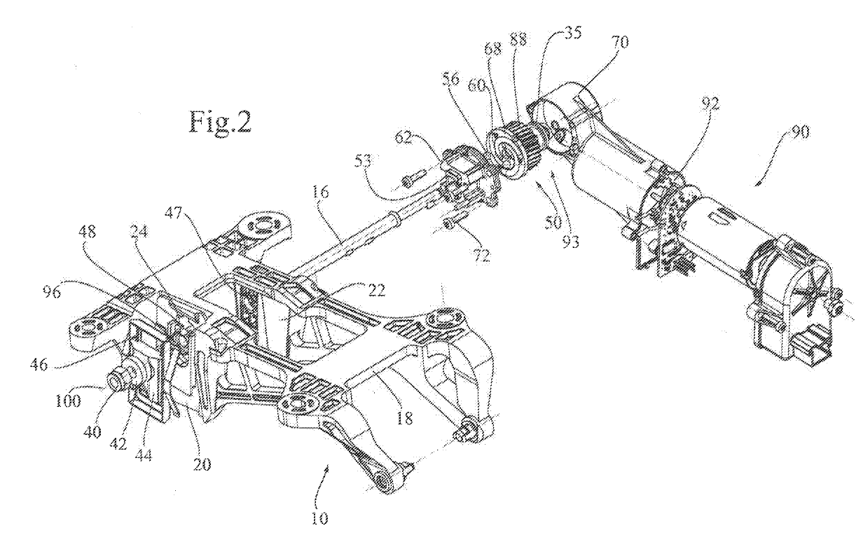

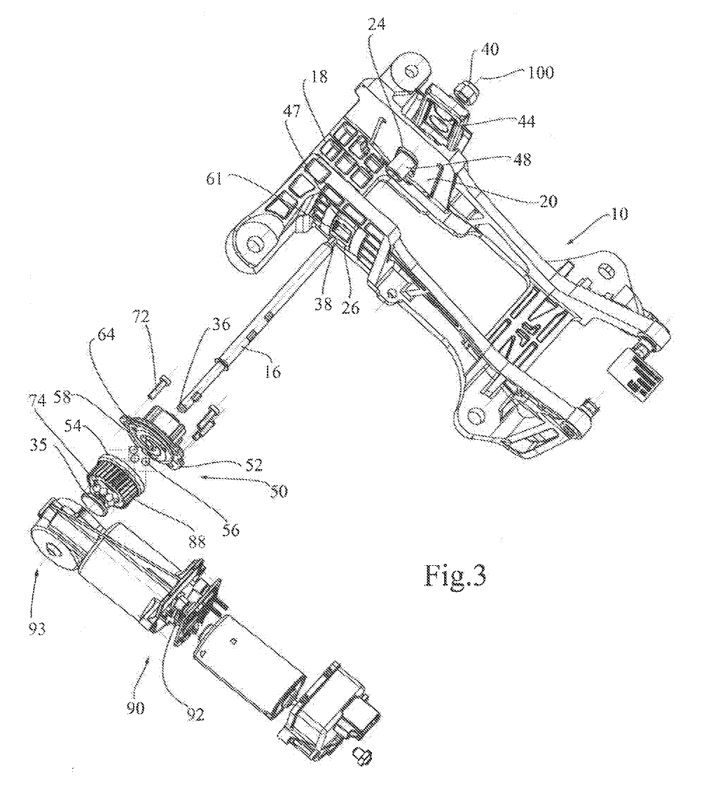

FIGS. 2 and 3, isometric views of the clamping mechanism of the steering column in FIG. 1;

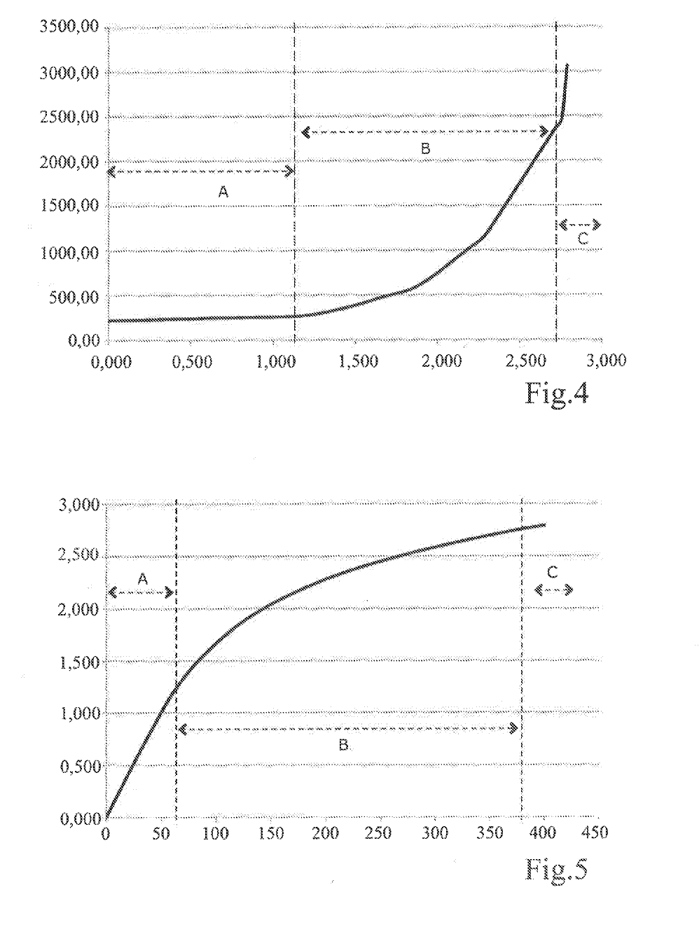

FIG. 4, a representation of the continuous function linking the movement of the tensioning member to the locking tension;

FIG. 5, a representation of the continuous function linking the movement of the movable cam to the translation of the tensioning members;

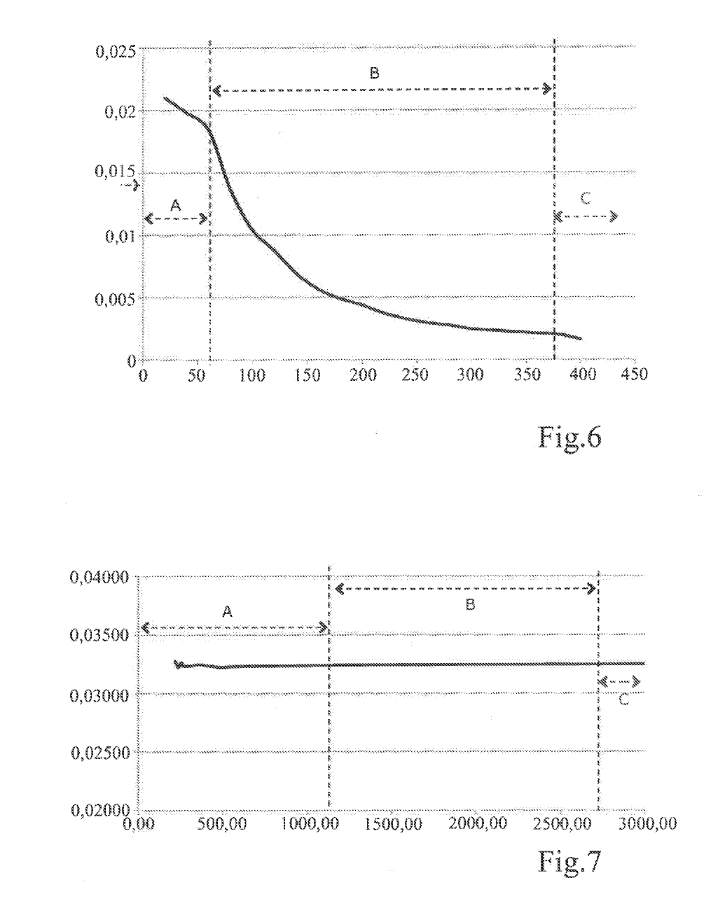

FIG. 6, a representation of the derivative of the continuous function of FIG. 5;

FIG. 7, a representation of the driving torque curve as a function of the locking tension;

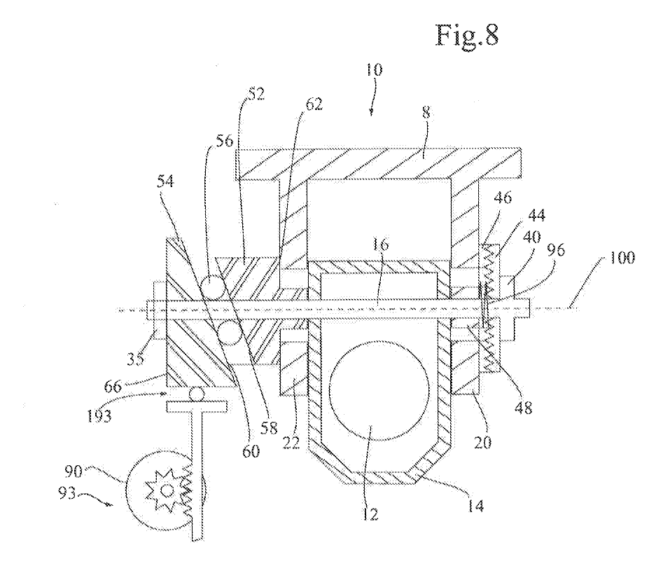

FIG. 8, a diagram of a variant of the invention presenting a linear-movement cam clamp mechanism.

For more clarity, the identical or similar elements are marked by identical reference signs on all the FIGS.

### DETAILED DESCRIPTION OF EMBODIMENTS

FIGS. 1 to 3 illustrate a steering column system comprising; a fixed support 10, a steering column tube body 12 inserted in a support 14 able to move with respect to the fixed support, a tensioning member 16, a cam clamp mechanism 50 and an actuator 90, here represented by an electric motor.

The fixed support 10 comprise a base 18 and two vertical flanges 20 and respectively 22, each pierced by an oblong aperture 24 and respectively 26, the major axis of which is oriented in a direction referred to as the direction for adjusting the steering column for height, in this case a direction that is vertical or close to vertical.

The movable support element 14 is slid between the two flanges 20 arid 22 of the fixed support 10. This movable support element 14 is secured to the tubs body 12 and has two walls 32, 34 parallel to the flanges 20, 22. Each of the walls 32 and respectively 34 is pierced by an aperture 28 and respectively 30, which may where applicable be oblong apertures the mag or axis of which is oriented in a direction referred to as the direction for adjusting the steering column depth, perpendicular or substantially perpendicular to the height adjustment direction defined by the oblong apertures 24, 26 of the fixed support.

The tensioning member 16 is formed by a rod equipped with a stop ring 35 clamped at one of its ends 36, the other end 38 being threaded and equipped with a nut 40. The clamping rod 16 defines a reference geometric axis 100, hereinafter referred as the clamping axis, and passes through the oblong apertures 24, 26, 28, 30 of the fixed support 10 and of the movable support 14. The nut 40 screwed at the threaded end 38 of the clamping rod 16 comes into abutment on an external wall of the flange 20 of the fixed support 10 of the steering column, where applicable by means of a washer 42 and a movable rack 44 in abutment against a fixed rack 46 secured to the flange 20. The clamping rod 16 is guided in the oblong apertures 24, 26 of the fixed support 10 by sliders 47, 48, which can slide on the lateral walls of the oblong apertures 24, 26 in the height adjustment direction, and form cylindrical surfaces in the clamping axis 100 for positioning of the rod.

FIGS. 2 and 3 show the clamping mechanism 50. This comprises; a first, cam, defining a reference frame 101 of the clamping mechanism and which will be referred to hereinafter as the fixed cam 52, a second cam, referred to hereinafter as the movable cam 54, and rolling bodies 56, here balls, that roll on rolling tracks 58, 60 formed on internal faces 64, 68 opposite the fixed cam 52 and movable cam 54.

The fixed cam 52 is mounted so as to slide on the clamping rod 16 and is provided with a relief 53 recessed in a conjugate cavity 51 of the slider 47 so as to be integral with the slider 47. The fixed cam 52 is in abutment on the flange 22 of the fixed support of the steering column, by an external face 62 opposite to the internal face 64. The external face 62 is planar and defines the reference geometric plane 101 of the clamping mechanism, perpendicular to the clamping axis 100.

The movable cam 54 is mounted slidably and free to rotate on the clamping rod and comprises an external face 65, opposite to the internal face 68, and which comes directly or indirectly into abutment on the stop ring 35 at the end 36 of the clamping rod 16. The movable cam 54 also forms a toothed wheel 88 that comes to be housed in a casing 70 of the actuator 90. This casing 70 is fixed to the fixed cam 52 by fixing screws 72 and makes it possible to house, apart from the electric motor 90 constituting the actuator proper, a worm 92 forming, with the toothed wheel 68, an intermediate angle transmission stage 93. Between the movable cam 54 and the stop ring 35, rolling bodies 74 are disposed so as to facilitate the rotation of the movable cam 54 about the clamping axis 100.

The rolling tracks 56, 58 are conformed so that the rotation of the movable cam with respect to the fixed cam about the clamping axis in the clamping direction causes a translation of the external surface 66 of the movable cam 54 with respect to the external surface 62 of the fixed cam 52, from an initial reference position corresponding to a minimum separation between the external surface 62 and 66.

The clamping mechanism is held by the stop ring 35 and by a disengagement spring 96, interposed between the slider 48 or the flange 20 and the movable rack 44.

The mechanism functions as follows. When the movable cam 54 is positioned in the reference position corresponding to a minimum separation between the external surfaces 62 and 66, the return spring 96, in abutment against the ring 42, returns the movable assembly consisting of the stop ring 35, the clamping rod 16 and the nut 40 towards the left in FIG. 1, into a position that tends to move the movable cam 54 closer to the fixed cam 52, so as to provide contact between the rolling bodies 56 and the rolling tracks 58, 60. The disengagement ring 95 tends to separate the movable rack 44 from the slider 48, so that the movable rack 44 is disengaged from the fixed rack 46. It is then possible to freely move, in a block, the movable rack 44, the sliders 47, 48, the clamping rod 16, the fixed 52 and movable 54 cams and the actuator 90 in the direction of adjustment of the steering column for height, parallel to the vertical plane defined by the flanges 20, 22. In the case where the movable support is also provided with oblong apertures oriented in the depth adjustment direction, it is also possible to move the same elements in the depth adjustment direction, still parallel to the vertical plane defined by the flanges 20, 22.

Once the position of the steering column has been adjusted, the clamping mechanism is activated. The actuator 90 rotates the movable cam 54 about the clamping axis 100 in the clamping direction. The rolling bodies 56 then move on the rolling tracks 58 of the fixed cam and the rolling tracks 60 of the movable cam 54. The external surfaces 62, 66 of the fixed 52 and movable 54 cams separate from each other parallel to the reference direction. The clamping rod 16 follows the movement of the movable cam 54, towards the right in FIG. 1, whereas the disengagement spring 96 tightens and the movable rack approaches the fixed rack. By continuing this movement, the two movable and fixed racks engage with each other, and the flanges are subjected to a bending stress and approach each other very slightly. The mechanism locks when the flanges come into abutment against the movable support.

As described up until now, this functioning is common to the invention and to the prior art. The contribution of the invention lies in the optimization of the dynamics of the locking movement, as will be discussed hereinafter.

The curve in FIG. 4 expresses the tension of the clamping member 16 (in ordinates, expressed in newtons) as a function of the movement of the clamping member 16 parallel to the clamping axis (in abscissae, expressed in millimetres). On this curve, various phases of clamping of the steering column in a position can be identified, namely at least one phase of bringing together and putting in contact of the various elements constituting the device for adjusting the column, referred to as the clearance-takeup phase (A), and of deformation of the parts with low stiffness, followed by a phase of elastic deformation (B) of the parts with greater stiffness. The clearance-takeup phase is characterised on the curve by a very slight slope, since the movement, of the rod gives rise to little or no force. The elastic deformation force begins when the elements constituting the clamping mechanism and the elements of the column are in contact, and is characterised by a variable and increasing slope. This is because the elements of the device having different stiffnesses are disposed in series, so that the movement of the clamping rod 16 causes firstly mainly the deformation of the element the stiffness of which is the least high, and then, when the maximum possible deformation of this element is reached, that of the following element and so on in order of increasing stiffness. A so-called locking phase (C) can also be distinguished, in which an additional force results in only an infinitesimal movement.

According to the invention, the rolling tracks 58, 60 of the cams 52, 54 or of one of them are conformed according to the phases thus identified, so as to limit as far as possible the variations in driving torque on the whole of the clamping travel.

The first so-called clearance-takeup part (A) has a fairly low tension of the clamping rod and therefore demands a fairly low power of the actuator; it is therefore possible to envisage, for a given, rotation speed of the movable cam 54, a rapid and large axial translation, of the tensioning member, that is to say a slope of the running tracks 58, 60 allowing a rapid and large movement of the external end 66 of the movable cam 54.

In the second part (B) for deformation of the flanges 20, 22 of the fixed support 10, the rotation speed of the movable cam remains constant, but the resulting translation of the rod is significantly slower than in the first part, and even smaller and smaller in the third so-called locking part (C), when the required locking is achieved.

FIG. 5 illustrates, for a depth profile of the running tracks according to the invention, the continuous function linking the movement of the end 66 of the movable cam 54 in translation parallel to the clamping axis 100 (in ordinates, in millimetres), to the rotation angle of the movable cam 54 about the clamping axis 100 (on the X axis, in degrees). Provided that the movable cam 54 is in abutment against the stop ring 35 secured to the clamping rod 16, and that the deformation of the clamping rod is negligible, this movement, corresponds to the movement of the clamping rod 16 with respect to the fixed cam 52, parallel to the clamping axis 100. It also corresponds to the variation in depth of the running track or tracks 60, 58 of the movable 54 and fixed 52 cams on which the rolling bodies 56 move according to the rotation angle of the movable cam 54 with respect to the fixed cam 52 about the clamping axis 100. As illustrated in FIG. 5, this continuous function is increasing, and the slope thereof is decreasing. This is also particularly visible in FIG. 6, which shows the derivative of the previous function, that is to say the slope of the running tracks 58, 60 as a function of the rotation angle of the movable cam 54. This derivative is indeed a decreasing non-constant function.

FIGS. 5 and 6 also show the various phases of the clamping travel identified previously. As can be seen, it has been chosen in the clearance-takeup phase (A) to form the running tracks 58, 60 so that the curve in FIG. 6 has a very steep slope. Purely indicatively, it is noted for example that a rotation of 50° of the movable cam 54 causes a movement of the clamping rod by 1 mm. During the elastic deformation phases (B) the movement of the clamping rod progresses more and more slowly; an additional rotation of 50° of the movable cam causes a movement of scarcely 0.7 mm and this movement decreases as the movable cam rotates. At the end of the rotation travel of the cam, between 350° and 400°, the movement of the clamping rod is around 0.05 mm. The slopes of the running tracks become less and less.

The depth of the running tracks is directly related to the curve in FIG. 5. This is because the Y axis in FIG. 5 can also be interpreted as the variation in distance between the external face 66 of the movable cam 54 and the external face 62 of the fixed cam 52, for a given rotation angle. If for example it is wished to have the depths of the running tracks 58, 60 changing identically on the fixed cam 52 and the movable cam 54, the variation in distance between the external face 66 of the movable cam 54 and the external face 62 of the fixed cam 52 corresponds to twice the variation in depth of the running tracks 58 and respectively 60 of each cam with respect to the corresponding external face 62 and respectively 66. If on the other hand it is wished for one of the cams, for example the fixed cam 52, to have a running track 58 the depth of which does not vary with respect to the external face 62 of the fixed cam 52, then the variation in distance in FIG. 6 corresponds to the variation in depth of the running track 60 of the movable cam 54 with respect to the external face 66 of the movable cam 54.

The resulting effect on the driving torque is illustrated in FIG. 7, which shows the variation in the driving torque (in ordinates, in Nm) as a function of the locking tension (in abscissae, in newtons) for a cam clamp mechanism where the running tracks are configured according to the invention. The curve has a fairly flat appearance, and the various phases of the clamping travel previously identified are difficult to locate, which indicates that the driving torque remains practically constant over the entire clamping travel of the steering column with the clamping mechanism according to the invention,

In a variant of the invention, shown schematically in FIG. 8, the actuator 30 drives the movable cam 54 in translation perpendicular to the clamping axis 100, by means of a movement transformation stage with rack 93 and a needle bearing 193. The movable cam 54 is in abutment against a stop ring 35 secured to the clamping rod 16, and kept pressed against the fixed cam 52 by a return spring 96. The movement of the movable cam 54 has a translation component perpendicular to the clamping axis 100 and a translation component parallel to the clamping axis 100, and, is accompanied by a movement of the clamping rod 16 by a value equivalent to the variation in distance between the external surfaces 66, 62 of the movable 54 and fixed 52 cams. As before, a single cam may have a profile equivalent to the required movement; or the two cams 52, 54 may have profiles that are very different but still complementary as to the resulting movement.

Other variants are possible. In particular, the translation movement along the clamping axis 10 0 in the clamping direction of the tensioning member 16 may be entirely borne by the characteristics of the rolling tracks of only one of the two fixed 52 and movable 54 cams. But also the slopes of the rolling tracks 58, 60 of the fixed earn 52 or of the movable cam 54 may not necessarily be symmetrical or equivalent, provided that they are complementary in order to obtain the movement of the clamping member corresponding to the required clamping travel.

The rolling tracks on which the rolling bodies move may have as many portions with different slopes as necessary for the locking of the steering column in a chosen position. Flat portions may also be envisaged, without modifications to the depth of the rolling tracks, which will indicate a phase of the clamping travel known as stabilization, or portions where the depth of the rolling tracks increases, a phase of the clamping travel referred to as reversal.

The rolling tracks may take all forms: circular or elliptical, they may change in the clamping direction, in the clockwise or anticlockwise direction; they may change from the centre of the cam towards the outside or vice versa. The number of rolling tracks carried by the cams is not limited. Ideally, three rolling tracks guarantee a flat surface, but the number thereon may be greater than three in order to reduce the contact pressures or less than three in order to limit friction between the various elements. The rolling bodies, held in cages, may be balls, or any other forms, rollers, needles, etc.

It is also possible to provide a sliding rather than rolling contact between movable cam 54 and fixed cam 52, for example with the interposition of sliding shoes on sliding tracks, the height of which varies so as to fulfil the required locking function.

The transmission stage 33 between actuator and movable cam 54 is not necessarily an angled transmission. It may be a transmission with parallel gears intended to offer a required step-down ratio between actuator 90 and movable cam 54. This stage may be completely omitted. The actuator may be purely linear, and consist for example of a cylinder. If this cylinder is intended to drive a rotary movable cam 54 as in the embodiment in FIGS. 1 to 3, a transmission stage is interposed in order to transform the linear movement of the actuator into a rotation movement of the movable cam, for example a rack transmission stage.

Naturally, the examples shown, in the FIGS. and discussed above are given only by way of illustration and non-1imitatively. Provision is explicitly made for it to be possible to combine together the various embodiments illustrated in order to propose others.

1. A cam clamping mechanism for locking an adjustable steering column in a position, comprising
a fixed cam defining a reference geometric plane of the clamping mechanism,
a tensioning member, the tensioning member being able to move at least in translation with respect to the fixed cam parallel to a clamping axis perpendicular to the reference plane, in a tensioning direction;
a movable cam able to move with respect to the fixed cam on a movement path in a clamping direction, and interacting with the fixed cam so that a movement of the movable cam on the movement path in the clamping direction causes a translation of the tensioning member parallel to the clamping axis in the tensioning direction,
wherein the movable cam and the fixed cam are conformed so that there exists a continuous function linking the movement of the movable cam in the clamping direction to the translation of the tensioning member parallel to the clamping axis in the tensioning direction, having a derivative that is a deceasing non-constant function.

2. The clamping mechanism of claim 1, wherein the movement path comprises a first part in which the derivative takes values higher than a first given threshold value, and a second part in which the derivative takes values lower than a second given threshold value, the first threshold value being higher than the second threshold value in a ratio greater than 2.

3. The clamping mechanism of claim 1, wherein, in a part of the movement path, the derivative has a zero value.

4. The clamping mechanism of claim 1, wherein, in a so-called locking part of the movement path, the derivative has negative values.

5. The clamping mechanism of claim 4, wherein the so-called locking part may be an end-of-travel position in the clamping direction.

6. The clamping mechanism of claim 1, wherein the tensioning member comprises a tensioning rod extending parallel to the clamping axis.

7. The clamping mechanism of claim 1, wherein it comprises one or more rolling bodies that roll on rolling tracks formed on the movable cam and the fixed cam.

8. The clamping mechanism of claim 7, wherein the running track or tracks of at least one of the two cams or have a varying depth or depths with non-constant slope or slopes.

9. The clamping mechanism of claim 1, further comprising an actuator directly or indirectly driving the movable cam on the movement path.

10. The clamping mechanism of claim 9, wherein the actuator is an electric motor.

11. The clamping mechanism of claim 9, wherein the actuator rotates the movable cam about the clamping axis.

12. The clamping mechanism of claim 9, wherein the actuator drives the movable cam in translation.

13. A steering column system comprising:
a fixed support
a steering column tube body able to move with respect to the fixed body;
the clamping mechanism of claim 1, one end of the tensioning member being secured to the fixed support in the tensioning direction.

14. The steering column system of claim 16, wherein the clamping mechanism further comprises an actuator directly or indirectly driving the movable cam on the movement path wherein the movable cam and the fixed cam are conformed so that, when the actuator drives the movable earn at constant speed in the clamping direction, the actuator supplies to the movable cam a mechanical power that is constant or varying by less than 10% over the movement path.

15. The clamping mechanism of claim 16, wherein the clamping mechanism further comprises an actuator directly or indirectly driving the movable cam on the movement path, wherein the movable cam and the fixed cam are conformed so that the movement path of the movable cam in the clamping direction does not cause any significant increase in the driving torque of the actuator.

16. A steering column system comprising;
a fixed support;
a steering column tube body able to move with respect to the fixed body;
a clamping mechanism for locking the adjustable steering column in a position, wherein the clamping mechanism comprises:
a fixed cam defining a reference geometric plane of the clamping mechanism,
a tensioning member, the tensioning member being able to move at least in translation with respect to the fixed cam parallel to a clamping axis perpendicular to the reference plane, in a tensioning direction, one end of the tensioning member being secured to the fixed support in the tensioning direction; and
a movable cam able to move with respect to the fixed earn on a movement path in a clamping direction, and interacting with the fixed cam so that a movement of the movable cam on the movement path in the clamping direction causes a translation of the tensioning member parallel to the clamping axis in the tensioning direction,
wherein the movable cam and the fixed earn are conformed so that there exists a continuous function linking the movement of the movable earn in the clamping direction to the translation of the tensioning member parallel to the clamping axis in the tensioning direction, having a derivative that is a deceasing non-constant function.

17. The clamping mechanism of claim 10, wherein the electric motor supplied at constant voltage,

18. The clamping mechanism of claim 9, wherein the actuator drives the movable cam in translation perpendicular to the clamping axis.

19. The clamping mechanism of claim 1, wherein the first threshold value being higher than the second threshold value in a ratio greater than 4.
